(19) United States
(12) Patent Application Publication
(10) Pub. No.: US 2010/0133040 A1
(43) Pub. Date: Jun. 3, 2010

(54) Roof clamp for fall protection safety equipment

(75) Inventor: Joseph Tony London, Stoneville, NC (US)

Correspondence Address: Joseph London, 1731 Price Grange Road, Stoneville, NC, 27048, US

(73) Assignee: Joseph Tony London, SR., Stoneville, NC (US)

(21) Appl. No.: 12/583,796

(22) Filed: Aug. 26, 2009

Related U.S. Application Data
(60) Provisional application No. 61/200,615, filed on Dec. 2, 2008.

(51) Int. Cl. E04D 13/12; E04G 21/32; A62B 35/00

(52) U.S. Cl. 182/3

(57) ABSTRACT

A multi part clamp for fall protection use on a standing seam roof. One component of the clamp is a clamp body with a slot formed within. This slot that may be so designed to allow attachment to multiple styles of standing seam roofs without having to slide the clamp body onto an end of a seam. Another component of the clamp is a pressure bar so designed as to apply pressure to the standing seam without puncturing or tearing the seam metal. Another component is one or more fasteners may be directed through the clamp body to apply pressure and secure the pressure bar to the roof seam and further secure the clamp to the standing seam. Another component is an attachment bracket on the clamp body for attaching a safety fall arrest system or harness to the clamp that is capable of maintaining load in four directions.

This application is based on provisional U.S. application No. 61/200,615 which is incorporated here in by reference.

### BACKGROUND OF THE INVENTION

This invention relates to roof safety devices for roof workers, and more specifically to a bracket used to attach a fall safety device to a seam roof system.

A seam roof is made up of multiple formed panels which are connected together. These connections, or seams, run the length of the roof and are spaced evenly along its width providing the building protection from exterior elements and are also formed in such a way as to be visually appealing. These seams are standardized within the roofing industry and create a convenient attachment point for a fall safety protection device.

Generally, the brackets used presently to attach a safety device to a roof consists of a plate which needs holes drilled or other fastening methods which deform or create holes in the roof panel. These holes or other deformations must be repaired and sealed from leaks causing considerable time and effort.

Moreover, the fixed bracket method does not allow easy movement over the roof and further limits the work area without having multiple brackets installed over the entire work space of the roof.

The safety environment and potential danger of falls related to both construction and maintenance preformed on seamed roof systems has been widely recognized and has been increasingly been under government regulatory scrutiny for protection of workers. Accordingly, there is presently a need for a roof safety bracket that can be attached to a seam roof system which can exceed present OSHA standards for fall protection, which can be quickly and easily repositioned by the worker, and which does not deform or create holes in the seam roof roofing panels.

### SUMMARY OF THE INVENTION

It would, therefore, be highly desirable to provide an improved fall protection anchor system which will allow secure attachment of a fall protection system to a seam roof while also providing ease of movement over the roof and without deforming the roof panels. It would also be desirable to have a system which will exceed support weights recommended by OSHA standards, and to which at least one and preferably two or more lifelines can be attached to hold approved personal fall protection devices.

The present invention provides a clamp for securing a fall protection safety line to a roof with formed seams. The clamp preferably is in the form of multiple person safety attachment point for use by the residential or commercial construction industry as an anchor point from which construction or contractor personal may attach an approved life line to which an approved personal fall arrest device may be attached.

The foregoing and additional advantages and characterizing features of the present invention will become clearly apparent upon reading of the ensuing detailed description together with the included drawings wherein:

### BRIEF DESCRIPTION OF THE DRAWINGS

FIG. 1 is an elevation view of a fall protection clamp according to the present invention as it would appear in use;

FIG. 2 Is a elevation view of the fall protection clamp;

FIG. 3 Is a plan view of the fall protection clamp;

FIG. 4A Is an elevation view of a raised seam roof;

FIG. 4B Is a plan view of a raised seam roof;

FIG. 5 Is an enlarged end view illustrating the installation of the clamp body onto a raised seam;

FIG. 6 Is a plan view of the clamp installed on a raised seam;

FIG. 7 Is a elevation view of the clamp installed on a raised seam;

FIG. 8A Is a clamp installed on a raised roof seam profile;

FIG. 8B Is a clamp installed on another raised roof seam profile;

FIG. 8C Is a clamp installed on another raised roof seam profile;

FIG. 8D Is a clamp installed on another raised roof seam profile;

FIG. 9A Is a plan view of the pressure bar;

FIG. 9B Is a partial elevation view of the pressure bar seat;

FIG. 10 Is a plan view of the clamp connector ring;

FIG. 11 Is a elevation view of the clamp connector ring assembly.

### DETAILED DESCRIPTION OF THE ILLUSTRATED EMBODIMENT

Referring to FIG. 1, there is shown a fall protection clamp 200 according to the present invention for securing at least one safety fall protection line to a seam roof 302 and the raised seam 301 present in this roof construction method. Each safety fall protection system line 401 coming from the fall protection clamp 200, in turn, is secured to an approved fall protection device 400 such as an approved safety belt, harness or the like as worn by roof workers. Seam roof 302 is made up of formed panels connected together in such a way to secure them to a building and also prevent outside weather elements from entering. These connections, or seams, run the length of the roof and are spaced along its width.

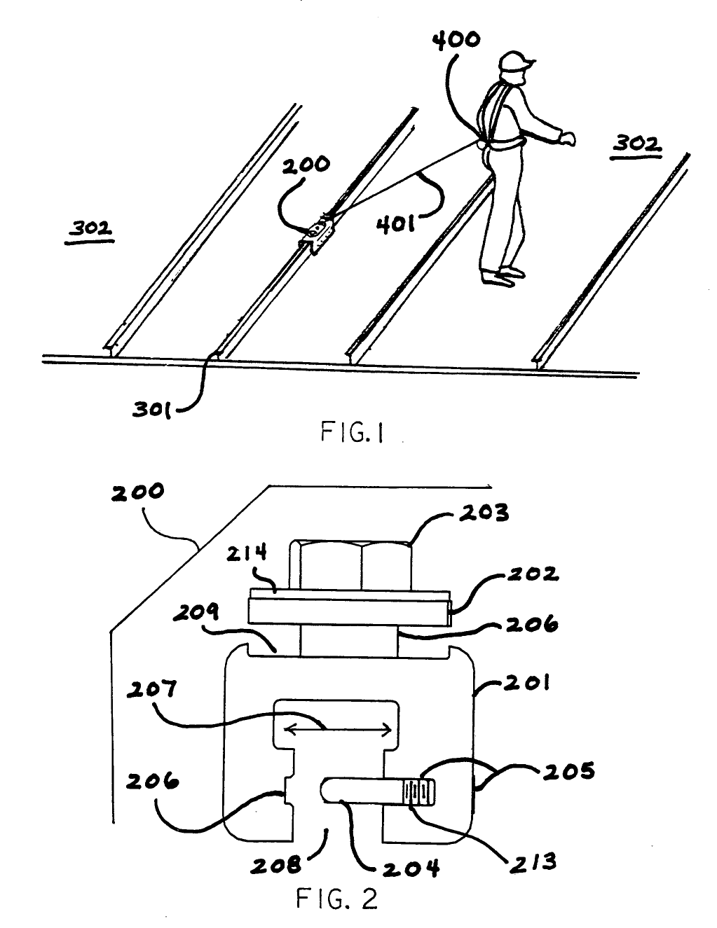

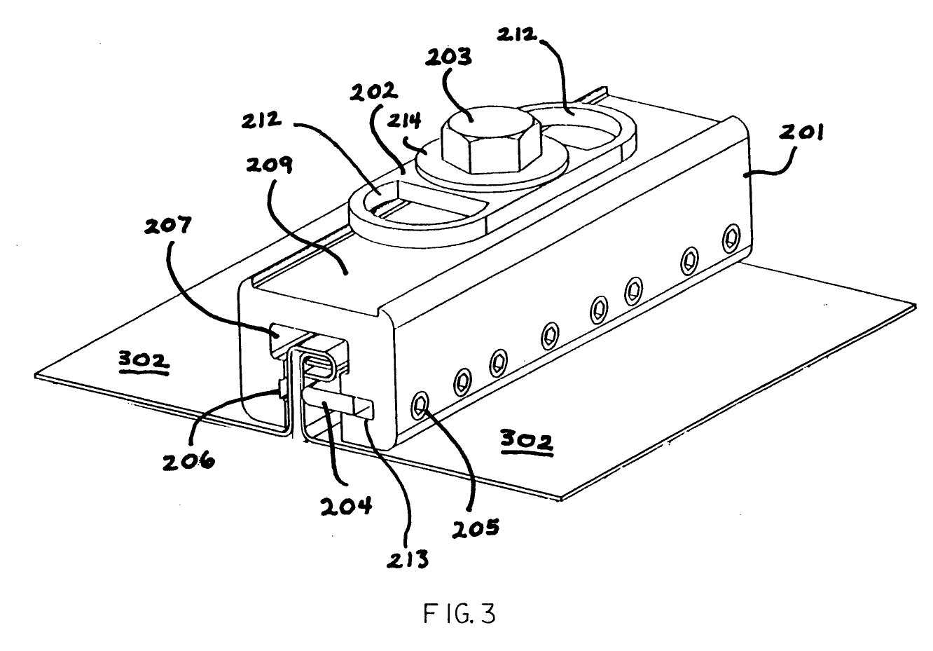

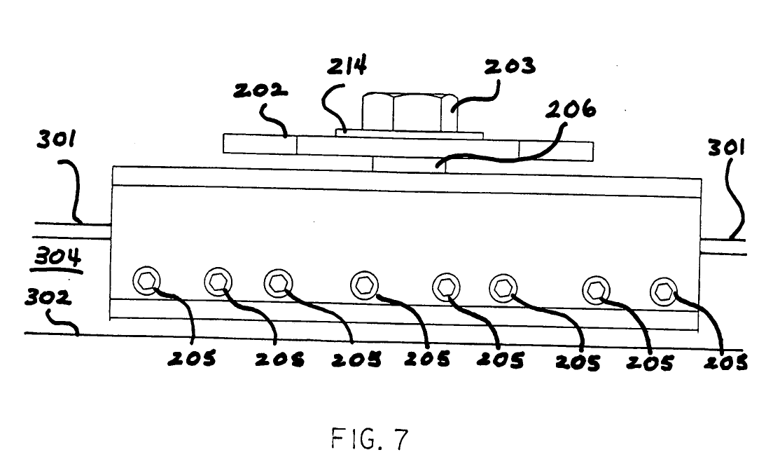

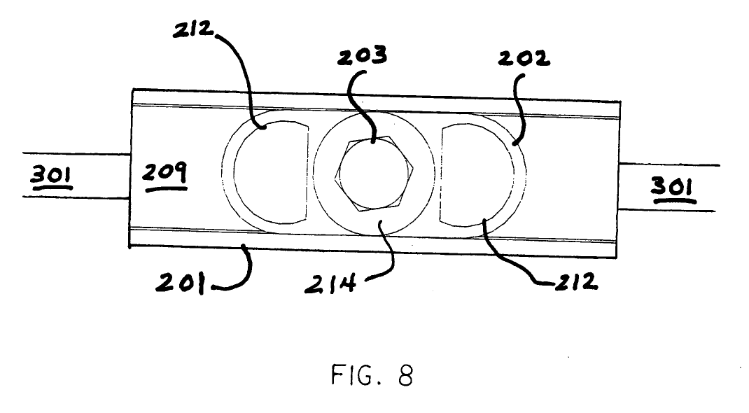

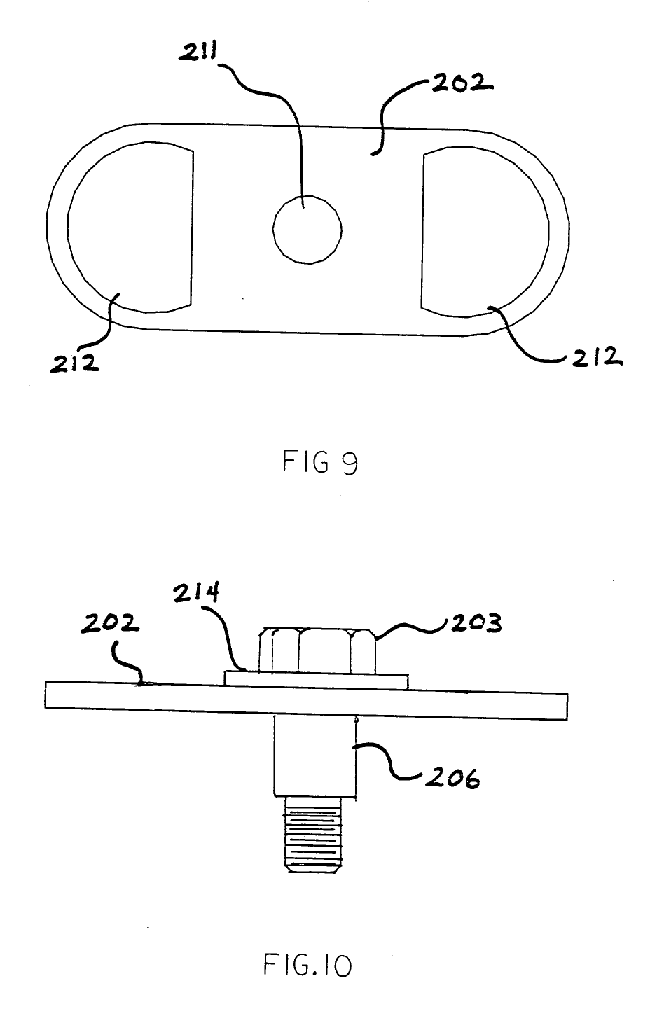

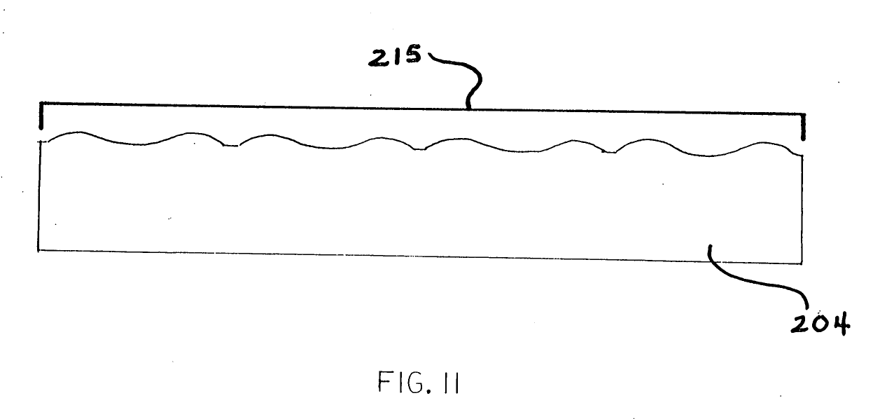

The clamp 200 is comprised of a single piece main body 201 made with a unique profile as illustrated in FIG. 2 and may be made by machine milling or extrusion and is made of aluminum. The profile slot is longitudinal and has opening 208 along its bottom. This slot is large enough to easily fit over the raised roof seam 301. The profile slot 207 allows multiple profiles of roof seams to fit within the main body piece 201. The opening 208 along the bottom of the main body 201 allows the clamp assembly to be installed along the length of the raised seam 301. Along the inside of the main body piece 201 running longitudinally is a pressure bar slot 213 which allows the insertion of the pressure 204 into the main body 201. The pressure bar 204 uses the set screws 205 positioned along the length of one side as illustrated in FIG. 7. The set screws 205 apply pressure to the pressure bar 204 and there by to the raised roof seam 301 along the length of the main body 201. The pressure imparted to the pressure bar 204 presses against the raised seam 301 forcing a portion of the raised seam 304 and 303 to also press into the body recess 206 which is part of the main body 201 profile. The pressure exerted is spread along the length of the raised seam 304 and 303.

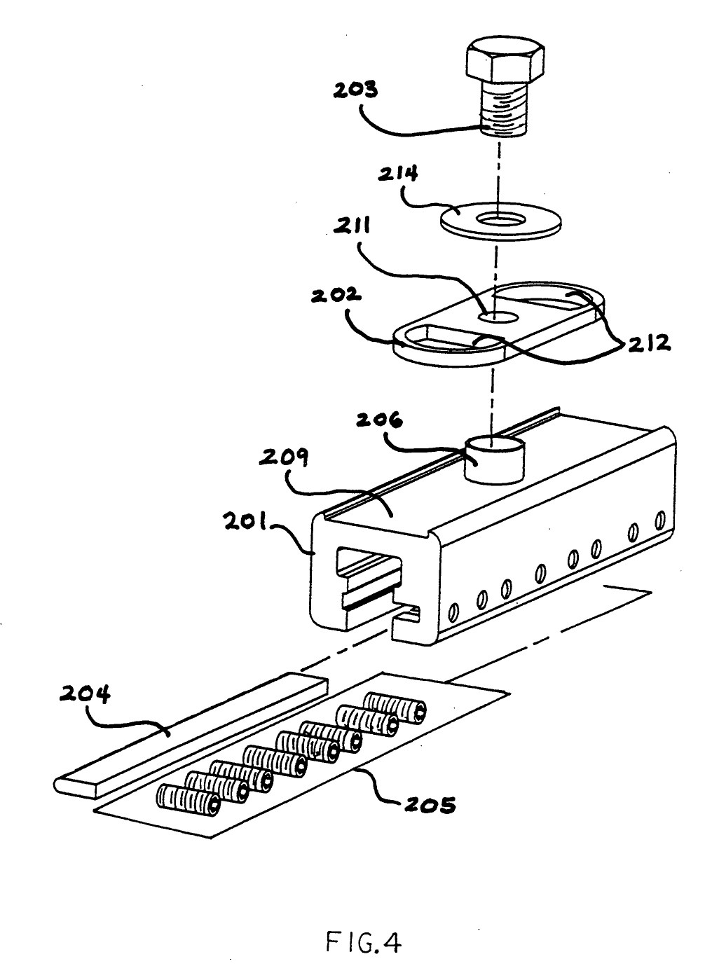

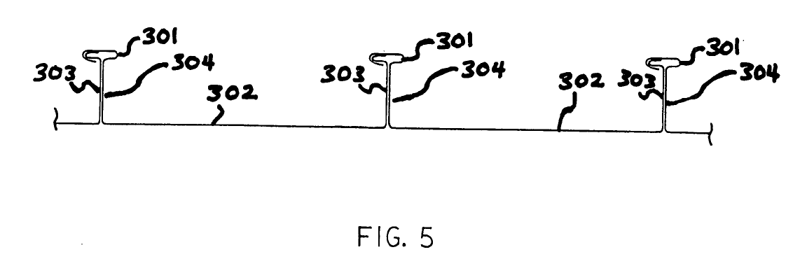

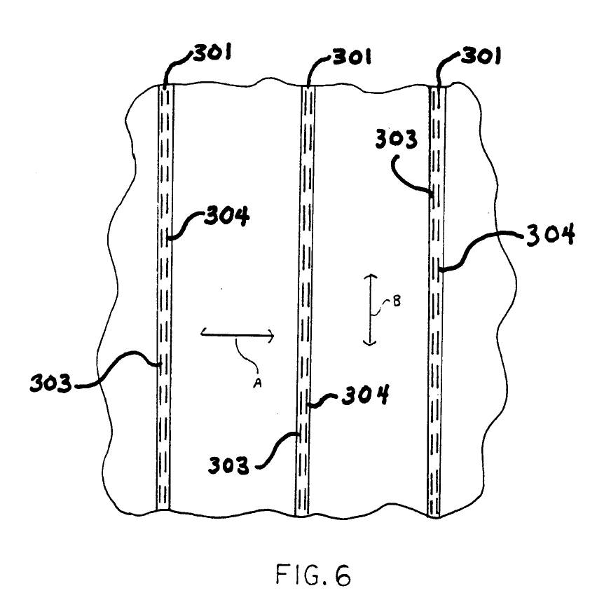

FIG. 4 illustrates a common profile of a raised seam roof system. The panels 302 are placed longitudinally on the roof and have a profile with vertical sides 303 and 304 and a seam top 301. The panels 302 are formed to allow locking together along the seam 301 and provide a roof system made up of individual panels. These interlocking panels 302 are arranged along the length as denoted in FIG. 6 as letter “B”. The panels 302 are also arranged along the width of the roof as demoted in FIG. 6 as letter “A”. FIG. 7 illustrates the clamp 200 installed properly along the raised seam 301. The set screws 205 impart force to the pressure bar 204. The pressure bar 204 imparts a clamping force along the longitudinal length of 304 and 303 as shown in FIG. 5 and as hidden lines in FIG. 6. This clamping force pushes against the recess 206 in the main body 201.

The attachment ring 202 is made from stainless steel material and is mounted to the top of the main body 201 by way of threads and the attachment bolt 203 and attachment washer 214. The attachment ring 202 has a tube spacer 206 which allows the attachment ring 202 to move up and down along the length of the spacer 206 and also rotate around the center hole 211. The attachment ring 202 is allowed to slide up for use and allows easy attachment and rotation around the attachment bolt 203 to a fall protection harness 401. The attachment ring 202 can also slide down along the tube spacer 206 and into the recess 209 along the length of the main body 201 to prevent the attachment ring 202 from moving when not in use or turning in high winds. The attachment ring 202 has two “D” shaped cut outs 212 for attachment of any commercially available fall protection devices 401 which further attaches to the fall protection harness assembly 400 worn by the roof worker as shown in FIG. 1.

The pressure bar 204 is made from stainless steel material and has a profile 215 as illustrated in FIG. 11 which allows the pressure bar 204 to push into the raised seam vertical parts 303 and 304 of the seam 301 without puncturing the panel. This profile also keeps the pressure bar 204 from slipping along the raised seam 301. The foregoing description of the present invention has been presented for purposes of illustration and description. Furthermore, the description is not intended to limit the invention to the form disclosed herein.

What is claimed is:

1. A method of connecting a safety fall arrest system to a standing seam roof.

2. A method that allows attachment of a safety fall arrest system to a standing seam roof without deforming the roof seam or having to puncture the roof.

3. A method of attachment that allows a single clamp design to be used on several different commonly used profiles of standing roof seams without having to slide the clamp body onto the end of a seam.

4. A method of attachment that meets government recommended safety standards for fall protection.

5. A method that allows temporary attachment of a safety fall arrest system.
